(19) United States
(12) Patent Application Publication
(10) Pub. No.: US 2021/0357887 A1
(43) Pub. Date: Nov. 18, 2021

(54) DIGITAL MONETARY REPOSITORY DISTRIBUTION AND TRACKING

(71) Applicant: PayPal, Inc., San Jose, CA (US)

(72) Inventor: Fabio Silva Carvalho, Austin, TX (US)

(21) Appl. No.: 16/874,876

(22) Filed: May 15, 2020

(51) Int. Cl. G06Q 20/10; G06Q 10/10; G06Q 40/02; G06Q 20/40; H04L 29/06

(52) U.S. Cl. CPC G06Q 20/108; G06Q 10/10; G06Q 2230/00; G06Q 20/40; H04L 63/104; G06Q 40/02

(57) ABSTRACT

Techniques regarding the management of a digital repository are provided. For example, one or more embodiments described herein can comprise a system, which can comprise a memory that can store computer executable components. The system can also comprise a processor, operably coupled to the memory, and that can execute the computer executable components stored in the memory. The computer executable components can comprise an access component that provides visibility access to a group of entities regarding transactions associated with a collective of digital monetary deposits, and provides management access to a management delegate of the group of entities. Further, the computer executable components can comprise a distribution component that in response to action of the management delegate distributes funds from the collective to the group of entities.

### TECHNICAL FIELD

This disclosure relates generally to automatic distributions across a group of entities from a digital monetary repository, and more specifically to, distributing funds from a digital monetary repository amongst a plurality of entities in accordance with one or more distribution policies, and rendering one or more features of the distribution visible to the plurality of entities.

### BACKGROUND

Traditionally, many financial transactions occur between individuals representing respective groups. For example, a venue owner may pay a band leader for a musical performance performed at the venue. Frequently in such occasions, members of the respective groups are not availed to the details of the transaction. Additionally, distribution of received payments can be traditionally left to the discretion of the individual who participated in the financial transaction. For instance, other members of the band may not be privy to the details of the payment, and the band leader may be solely responsible for distribution of the payment amongst the band members. Thus, the financial transaction can become very tedious; involving people having to travel to places to collect, deposit, and distribute funds. Additionally, the members of the parties to the transaction may not have any visibility to the overall money involved or its distribution.

### BRIEF DESCRIPTION OF THE DRAWINGS

FIG. 1 illustrates a block diagram of an example, non-limiting system that can include a repository management component that can automatically coordinate digital monetary distributions amongst a group of entities in accordance with one or more embodiments described herein.

FIG. 2 illustrates a block diagram of an example, non-limiting system that can include a membership component that can manage the composition of a group of entities in preparation for a digital monetary distribution in accordance with one or more embodiments described herein.

FIG. 3 illustrates a block diagram of an example, non-limiting system that can include a policy component that can define one or more distribution policies associated with a digital monetary repository in accordance with one or more embodiments described herein.

FIG. 4 illustrates a block diagram of an example, non-limiting system that can include a modification component that can modify one or more distribution policies associated with a digital monetary repository in accordance with one or more embodiments described herein.

FIG. 5 illustrates a block diagram of an example, non-limiting system that can include a reservation component that can reserve a portion of a deposit into a digital monetary repository from distribution in accordance with one or more embodiments described herein.

FIG. 6 illustrates a block diagram of an example, non-limiting system that can include a permissions component that can ascertain one or more permissions from a group of entities regarding a withdrawal of reserved funds from a digital monetary repository in accordance with one or more embodiments described herein.

FIG. 7 illustrates a block diagram of an example, non-limiting system that can include a report component that can generate one or more reports regarding the status and/or operation of a digital monetary repository in accordance with one or more embodiments described herein.

FIG. 8 illustrates a flow diagram of an example, non-limiting computer-implemented method that can facilitate automatic coordination of digital monetary distributions amongst a group of entities in accordance with one or more embodiments described herein.

FIG. 9 illustrates a flow diagram of an example, non-limiting computer-implemented method that can facilitate automatic coordination of digital monetary distributions amongst a group of entities in accordance with one or more embodiments described herein.

FIG. 10 illustrates a block diagram of an example, non-limiting operating environment in which one or more embodiments described herein can be facilitated.

FIG. 11 illustrates a block diagram of an example, non-limiting sample-computing environment in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can include a memory and a processor configured to execute computer instructions stored in the memory that when executed cause the system to perform operations. The computer instructions can further comprise an access component that provides visibility access to a group of entities regarding transactions associated with a collective of digital monetary deposits. Additionally the computer instructions can comprise a distribution component that in response to action of the management delegate distributes funds from the collective to the group of entities.

According another embodiment, a computer-implemented method is provided. The computer-implemented method can comprise granting, by a system operatively coupled to a processor, a group of entities monitoring access to a digital monetary repository. Further, the computer-implemented method can comprise distributing, by the system, funds from the digital monetary repository to an entity from the group of entities in response to a triggering event, wherein the monitoring access renders a balance of the digital monetary repository and the distributing visible to the group of entities.

According to a further embodiment, a non-transitory computer readable medium is provided. The non-transitory computer readable medium can comprise instructions that, in response to execution, cause a system including a processor and memory to perform operations comprising associating a plurality of entities with a digital monetary repository, wherein the plurality of entities have monitoring access to the digital monetary repository that renders deposits, withdraws, and balances of the digital monetary repository visible. The operations can further comprise distributing funds from the digital monetary repository to one or more entities from the plurality of entities in response to a deposit made into the digital monetary repository.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Various embodiments of the present invention can be directed to computer processing systems, computer-implemented methods, apparatus and/or computer program products that facilitate the efficient, effective, and autonomous (e.g., without direct human guidance) distribution and tracking of funds from a digital monetary repository. For example, one or more embodiments described herein can regard distributing funds from a digital monetary repository amongst a variety of entities in accordance with one or more distribution policies and in response to one or more triggering events. For example, the one or more distribution policies can be triggered by the occurrence of one or more deposits to the digital monetary repository. For instance, the distribution policies can delineate which entities are to be involved in the distribution of funds and/or how the funds will be distributed to the designated entities (e.g., how much funding each entity receives by the distribution). Additionally, various embodiments described herein can be employed to manage the composition of entities involved in the distribution, and/or modify the distribution policies based on one or more defined contexts. For example, the distribution policies can vary based on the source of a deposit to the digital monetary repository. Moreover, one or more embodiments described herein can grant monitoring access to the one or more entities and/or generate status reports such that financial details of the distribution and/or the digital monetary repository can be visible to the various entities involved.

The computer processing systems, computer-implemented methods, apparatus and/or computer program products employ hardware and/or software to solve problems that are highly technical in nature (e.g., automatic distribution of funds from a digital monetary repository), that are not abstract and cannot be performed as a set of mental acts by a human. For example, an individual, or a plurality of individuals, cannot readily manage a digital monetary repository with the level of transparency and/or efficiency as the various embodiments described herein. For instance, the autonomous nature of the systems, computer program products, and/or computer-implemented methods described herein, can enable transparency regarding management of the digital monetary repository and can alleviate concerns that would otherwise arise from human management, such as concerns regarding misappropriation of funds.

Also, one or more embodiments described herein can constitute a technical improvement over conventional fund distributions by employing digital monetary distributions automatically in accordance with distribution policies that can be viewed and/or agreed upon by the various entities associated with a digital monetary repository. Additionally, various embodiments described herein can demonstrate a technical improvement over conventional transaction management systems by increasing monitoring access of a digital monetary repository and transactions involving the repository to a plurality of entities associated with the repository. For example, various embodiments described herein can enable various entities involved in a distribution of funds to view at least how much monetary funds was distributed, who received the distributed funds, and/or the policies governing the distribution. Further, one or more embodiments described herein can have a practical application by enabling a group of entities to automate management of a digital monetary repository in accordance with known policies and/or agreed upon levels of transparency.

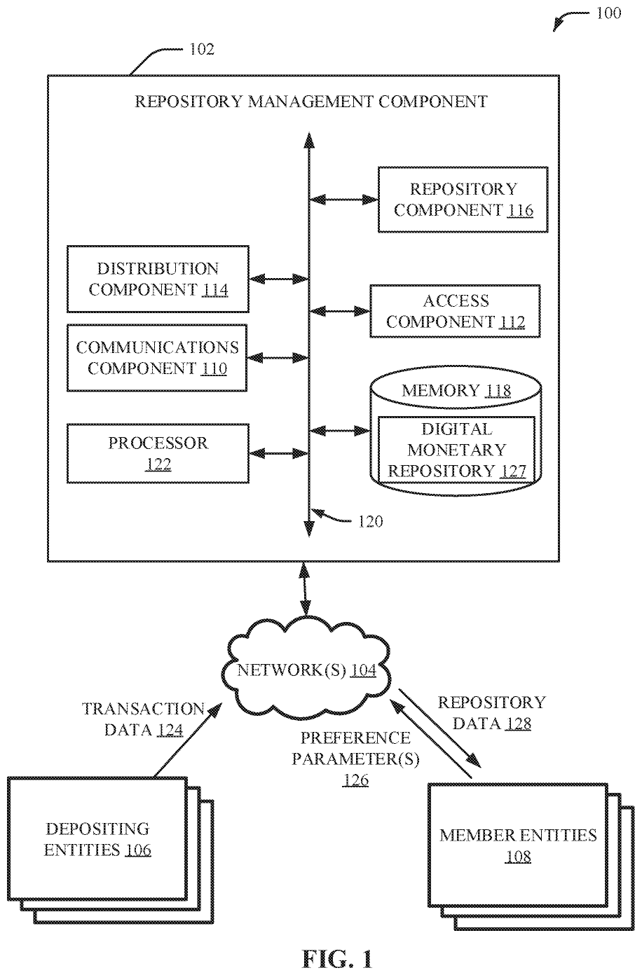

FIG. 1 illustrates a block diagram of an example, non-limiting system 100 that can automate the distribution of funds from a digital monetary repository among a plurality of entities. Repetitive description of like elements employed in other embodiments described herein is omitted for sake of brevity. Aspects of systems (e.g., system 100 and the like), apparatuses or processes in various embodiments of the present invention can constitute one or more machine-executable components embodied within one or more machines, e.g., embodied in one or more computer readable mediums (or media) associated with one or more machines. Such components, when executed by the one or more machines, e.g., computers, computing devices, virtual machines, etc. can cause the machines to perform the operations described.

As shown in FIG. 1, the system 100 can comprise one or more repository management component 102, one or more networks 104, depositing entities 106, and/or member entities 108. The system 100 can be implemented on or in connection with a network of servers associated with a digital monetary funds application. In one example, the system 100 can be associated with a cloud-based platform. In an embodiment, the system 100 can be associated with a computing environment that comprises one or more servers and/or one or more software components that operate to perform one or more processes, one or more functions and/or one or more methodologies in accordance with the described embodiments. A sever as disclosed herein can include, for example, stand-alone server and/or an enterprise-class server operating a server operating system (OS) such as a MICROSOFT® OS, a UNIX® OS, a LINUX® OS, and/or another suitable server-based OS. It is to be appreciated that one or more operations performed by a server and/or one or more services provided by a server can be combined, distributed, and/or separated for a given implementation. Furthermore, one or more servers can be operated and/or maintained by a corresponding entity or different entities. The system 100 can be employed by various systems, such as, but not limited to fraud prevention systems, risk management systems, transaction systems, payment systems, online transaction systems, online payment systems, server systems, electronic device systems, mobile device systems, smartphone systems, virtual machine systems, consumer service systems, security systems, mobile application systems, financial systems, digital systems, machine learning systems, artificial intelligence systems, neural network systems, network systems, computer network systems, communication systems, enterprise systems, a time-management system, a scheduling system, an electronic calendaring system, an asset management system, a work and productivity system, an email system, a cloud storage system, a messaging system, a social networking system, a note-taking system, a word processor system, a spreadsheet system, a presentation program system, and the like. In one example, the system 100 can be associated with a Platform-as-a-Service (PaaS). Moreover, the system 100 and/or the components of the system 100 can be employed to use hardware and/or software to solve problems that are highly technical in nature (e.g., related to artificial intelligence, related to machine learning, related to digital data processing, etc.), that are not abstract and that cannot be performed as a set of mental acts by a human.

As shown in FIG. 1, the repository management component 102 can further comprise communications component 110, access component 112, distribution component 114, and/or repository component 116. Also, the server 102 can comprise or otherwise be associated with at least one memory 118. The server 102 can further comprise a system bus 120 that can couple to various components such as, but not limited to, the repository management component 102 and associated components, memory 118 and/or a processor 122.

In various embodiments, communications component 110, access component 112, distribution component 114, and/or repository component 116 can be implemented as stored software instructions that are executable by processor 122 to cause particular operations to occur. Aspects of the systems, apparatuses or processes explained in this disclosure can constitute one or more machine-executable components embodied within one or more machines (e.g., embodied in one or more computer readable mediums (or media) associated with one or more machines). The one or more embodiments, when executed by the one or more machines (e.g., one or more computers, computing devices, virtual machines, etc.) can cause the one or more machines to perform the operations described. The system 100 (e.g., the repository management component 102) can include memory 118 for storing computer executable components and instructions. The system 100 (e.g., the repository management component 102) can further include the processor 122 to facilitate operation of the instructions (e.g., computer executable components and instructions) by the system 100 (e.g., the repository management component 102).

The one or more networks 104 can comprise wired and wireless networks, including, but not limited to, a cellular network, a wide area network (WAN) (e.g., the Internet) or a local area network (LAN). For example, the repository management component 102 can communicate with the one or more depositing entities 106 and/or member entities 108 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like.

In various embodiments, the repository management component 102 can receive transaction data 124 from the one or more depositing entities 106. For example the communications component 110 can receive the transaction data 124 via the one or more networks 104 and share the transaction data 124 with one or more associate components of the repository management component 102 (e.g., via system bus 120). The one or more depositing entities 106 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. The one or more depositing entities 106 can be employed to enter the transaction data 124 into the system 100, thereby sharing (e.g., via a direct connection and/or via the one or more networks 104) the transaction data 124 with the repository management component 102. For example, the one or more depositing entities 106 can send data to the communications component 110 (e.g., via a direct connection and/or via the one or more networks 104). Further, in one or more embodiments, the one or more depositing entities 106 can be comprised within, and/or operably coupled to, a cloud computing environment.

The transaction data 124 can be data related to one or more transactions associated with one or more computing devices. The transaction data 124 can also be associated with one or more events (e.g., one or more transaction events) associated with one or more computing devices. In an aspect, an event associated with the transaction data 124 can include a numerical value corresponding to an amount for a transaction. Additionally or alternatively, an event associated with the transaction data 124 can include time data related to a timestamp for the transaction. An event associated with the transaction data 124 can additionally or alternatively include an item associated with the transaction and/or an identifier for one or more entities associated with the transaction. In various embodiments, the transaction data 124 can include a set of transaction requests for an online transaction system. For example, the transaction data 124 can be financial transaction data. For instance, the transaction data 124 can be data to facilitate a transfer of funds for transactions between two entities. The one or more computing devices associated with the transaction data 124 can be one or more client devices, one or more user devices, one or more electronic devices one or more mobile devices, one or more smart devices, one or more smart phones, one or more tablet devices, one or more handheld devices, one or more portable computing devices, one or more wearable devices, one or more virtual reality devices, one or more computers, one or more desktop computers, one or more laptop computers, one or more point of sale (“POS”) devices and/or one or more other types of electronic devices associated with a display.

In various embodiments, the repository management component 102 can receive one or more preference parameters 126 from the one or more member entities 108. For example the communications component 110 can receive the one or more preference parameters 126 via the one or more networks 104 and share the one or more preference parameters 126 with one or more associate components of the repository management component 102 (e.g., via system bus 120). The one or more member entities 108 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. The one or more member entities 108 can be employed to enter one or more preference parameters 126 into the system 100, thereby sharing (e.g., via a direct connection and/or via the one or more networks 104) the preference parameters with the repository management component 102. For example, the one or more member entities 108 can send data to the communications component 110 (e.g., via a direct connection and/or via the one or more networks 104). Additionally, the one or more member entities 108 can comprise one or more displays that can present one or more outputs generated by the system 100 to a user. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

In various embodiments, the one or more member entities 108 and/or the one or more networks 104 can be employed to input one or more settings and/or commands into the system 100. Additionally, the one or more member entities 108 can be employed to display one or more outputs (e.g., displays, data, visualizations, and/or the like) generated by the repository management component 102 and/or associate components. Further, in one or more embodiments, the one or more member entities 108 can be comprised within, and/or operably coupled to, a cloud computing environment.

The one or more preference parameters 126 can be data related to one or more preferred settings and/or parameters associated with a digital monetary repository 127 (e.g., stored in the one or more memories 118) and/or distribution of funds from the repository. The one or more preference parameters 126 can also be associated with one or more events (e.g., one or more election events) associated with one or more computing devices. In an aspect, an event associated with the preference parameters 126 can include a numerical value corresponding to an election result and/or a selection for one or more options from a plurality of available options. Additionally or alternatively, an event associated with the preference parameters 126 can include time data related to a timestamp for the elected preference. An event associated with the preference parameters 126 can additionally or alternatively regard a policy setting associated with one or more distribution policies described herein. In various embodiments, the preference parameters 126 can be responses to one or more polls, elections, surveys, and/or questionnaires generated by the repository management component 102 and/or associate components. The one or more computing devices associated with the preference parameters 126 can be one or more client devices, one or more user devices, one or more electronic devices one or more mobile devices, one or more smart devices, one or more smart phones, one or more tablet devices, one or more handheld devices, one or more portable computing devices, one or more wearable devices, one or more virtual reality devices, one or more computers, one or more desktop computers, one or more laptop computers, one or more POS devices and/or one or more other types of electronic devices associated with a display.

In various embodiments, the repository management component 102 can further share repository data 128 with the one or more member entities 108. The repository data 128 can be data related to one or more distributions from a digital monetary repository 127. The repository data 128 can also regard monitoring access, status reports, operation reports, and/or balances associated with the digital monetary repository 127. For instance, the repository data 128 can include one or more reports regarding historic status of the digital monetary repository; such as, for example: a transaction history of the digital monetary repository, a balance of the digital monetary repository, a distribution of funds from the digital monetary repository, a combination thereof, and/or the like.

In one or more embodiments, the repository management component 102 can automatically manage a digital monetary repository 127 associated with the one or more member entities 108 based on the transaction data 124 and/or preference parameters 126. For example, the repository management component 102 can automatically distribute funds from the digital monetary repository 127 to the one or more member entities 108 in response to one or more triggering events (e.g., in response to a deposit) and/or based on transaction data 124. For instance, the automatic distribution can be performed in accordance with one or more distribution policies defined by the one or more member entities 108. In another example, the repository management component 102 can manage an entity roster that delineates the one or more member entities associated with the digital monetary repository 127. In a further example, the repository management component 102 can grant monitoring access regarding the digital monetary repository 127 to the one or more member entities 108 (e.g., by sharing the repository data 128, including one or more status and/or operation reports).

In various embodiments, the repository component 116 can define a digital monetary repository 127. In various embodiments, the digital monetary repository 127 can be stored in one or more memories 118. For example, the digital monetary repository 127 can serve as a digital financial account, such as a digital checking and/or savings account. In one or more embodiments, the repository component 116 can define the digital monetary repository 127 in one or more financial computing platforms that facilitate execution of one or more financial transactions between parties via computer devices (e.g., financial transaction between the one or more depositing entities 106 and/or member entities 108). Further, the repository component 116 can update the transaction history and/or balance of the digital monetary repository 127 based on the transaction data 124 received by the communications component 110 and/or fund distributions performed by the distribution component 114. For example, the repository component 116 can update the balance of the digital monetary repository 127 based on deposits made to the repository (e.g., as defined by the transaction data 124) and/or withdraws made from the repository (e.g., as performed by the distribution component 114). Thus, the digital monetary repository 127 can be a collective of digital monetary deposits, wherein the repository component 116 can update the balance of the collective based on the transaction data 124 and/or fund distributions in accordance with the various embodiments described herein.

For instance, transaction data 124 can be sent to the communications component 110 by the one or more depositing entities 106 in response to the execution of a financial transaction between the depositing entities 106 and the one or more member entities 108. The transaction data 124 can include, for example: an identification of the member entities 108 to be paid, an amount of money to be paid to the identified member entities 108, when the payment is executed, any other details regarding the financial transaction (e.g., a description of services rendered, a receipt, a transaction identification number, etc.), a combination thereof, and/or the like. The communications component 110 can share the transaction data 124 with the repository component 116, and the repository component 116 can analyze the transaction data to: identify the digital monetary repository 127 associated with the designated member entities 108, and update the balance of the identified digital monetary repository 127 to reflect a deposit of the payment.

The access component 112 can provide monitoring access to the member entities 108 regarding one or more transactions associated with the digital monetary repository 127. Additionally, the access component 112 can provide management access to one or more management delegates of the member entities 108. The monitoring access can render transactions involving the digital monetary repository 127 visible to the member entities 108 associated with the digital monetary repository 127. The management access can permit the one or more management delegates of the member entities 108 to set, create, and/or modify one or more distribution policies and/or settings of the repository management component 102. In various embodiments, each of the member entities 108 can be associated with one or more identifiers (e.g., an identification number and/or code), wherein the access component 112 can assign monitory access and/or management access to member entities 108 based on the one or more identifiers and/or in accordance with the various embodiments described herein.

For example, the access component 112 can grant permission to the member entities 108 to monitor: the updates performed by the repository component 116, the transaction data 124 regarding the digital monetary repository 127 associated with the member entities 108, distributions performed by the distribution component 114, a combination thereof, and/or the like. For instance, the access component 112 can enable the member entities 108 to monitor the transaction data 124 regarding one or more deposits to the digital monetary repository 127 associated with the member entities 108. In another instance, the access component 112 can enable the member entities 108 to monitor one or more withdraws from the digital monetary repository 127 associated with the member entities 108. Furthermore, in various embodiments the access component 112 can enable the one or more member entities 108 to view one or more distribution policies and/or settings implemented by the repository management component 102. Moreover, in one or more embodiments, the monitoring access granted and/or otherwise enabled by the access component 112 can be shared with the one or more member entities 108 as the repository data 128.

In various embodiments, the distribution component 114 can distribute funds from the digital monetary repository 127 to the member entities 108 in accordance with one or more distribution policies (e.g., stored in the one or more memories 118). Further, the funds can be distributed as repository data 128 shared with one or more of the member entities 108. The distribution policies can delineate how the funds are distributed and/or under what contexts the funds are distributed. For example, the one or more distribution policies can delineate an equal or unequal distribution of funds amongst the member entities 108. For instance, the distribution policy can delineate a distribution of equal amounts of funds to each of the member entities 108. In another instance, the distribution policy can delineate a respective amount of funds to individual member entities 108. Further, the distribution policies can characterize the amounts of funds as a defined sum and/or a defined percentage.

Additionally, the distribution component 114 can implement the distribution policies in response to one or more triggering events (e.g., wherein the triggering events can be characterized within the distribution policy). For example, the triggering event can be the occurrence of a deposit to the digital monetary repository 127. For instance, the distribution component 114 can implement the one or more distribution policies in response to the repository component 116 updating the digital monetary repository 127 to reflect one or more deposits described by the transaction data 124. In another example, the triggering event can be a scheduled distribution appointment. For instance, the distribution component 114 can implement the one or more distribution policies based on one or more schedules, such as time intervals (e.g., weekly, monthly, and/or the like) and/or appointment dates.

Moreover, the one or more distribution policies can characterize the amount of funds to be distributed. For example, wherein the triggering event for a distribution policy is the occurrence of a deposit, the distribution policy can further delineate how much of the deposit is subject to distribution by the distribution component. For instance, the distribution policy can denote a percentage of the deposit for distribution amongst one or more of the member entities 108 (e.g., a percentage that is less than or equal to 100 percent). In another example, the one or more distribution policies can delineate a portion (e.g., a defined percentage) of the balance of the digital monetary repository 127 for distribution amongst the one or more member entities. In a further example, the one or more distribution policy can delineate a defined sum to be distributed amongst one or more of the member entities 108. For instance, the distribution policy can delineate a defined sum and/or balance percentage to be distributed by the distribution component 114 in accordance with one or more schedules.

In addition, the one or more distribution policies can describe one or more conditions for fund distribution by the distribution component 114. For example, the one or more conditions can be derived from the transaction data 124. For instance, one or more distribution policies can direct distribution of funds by the distribution component 114 to only those member entities 108 described by the transaction data 124. The transaction data 124 can describe one or more respective member entities 108 (e.g., via reference to one or more identifiers) associated with a deposit to the monetary digital repository, and/or one or more distribution policies can condition distribution of the deposit, or a portion of the deposit, to only those respective member entities 108. In another instance, one or more distribution policies can direct distribution of funds by the distribution component 114 to respective member entities 108 associated with a source of the transaction data 124. The transaction data 124 can describe a source of the deposit, and/or one or more distribution policies can condition distribution of the deposit, or a portion of the deposit, to respective member entities 108 associated with the deposit source.

While FIG. 1 depicts separate components in the repository management component 102, it is to be appreciated that two or more components can be implemented in a common component. Further, it can be appreciated that the design of system 100 and/or repository management component 102 can include other component selections, component placements, etc., to facilitate management of the digital monetary repository 127 with regards to the member entities 108.

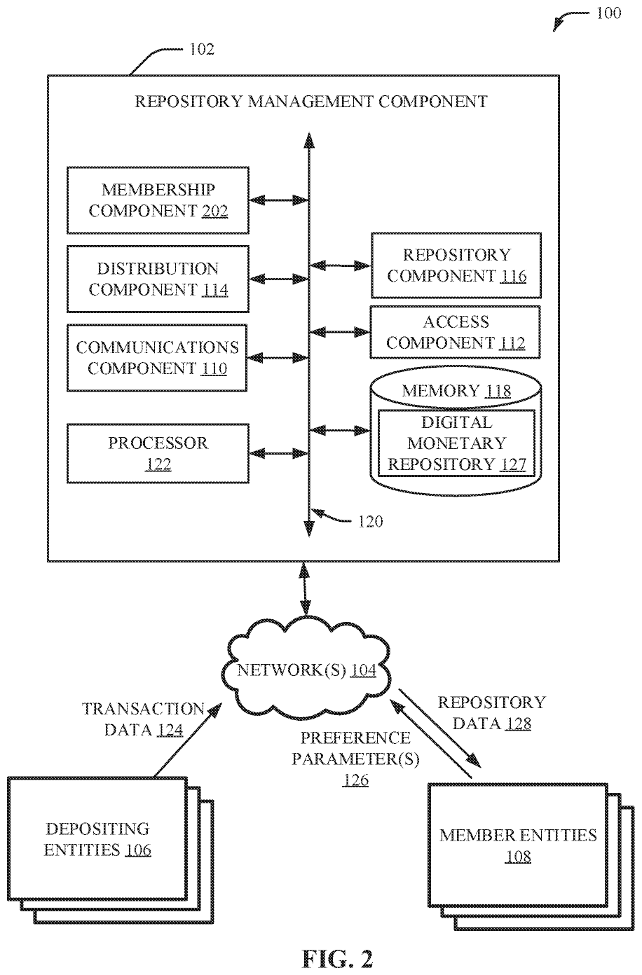

FIG. 2 illustrates the example, non-limiting system 100 further comprising membership component 202 in accordance with various embodiments described herein. Repetitive description of like elements employed in other embodiments described herein is omitted for sake of brevity. In various embodiments, the membership component 202 can manage one or more entity rosters regarding the one or more member entities 108 based on the one or more preference parameters 126. For example, the one or more entity rosters can define a composition of the member entities 108 associated with the digital monetary repository 127 defined and/or updated by the repository component 116.

In various embodiments, the membership component 202 can generate one or more entity rosters that pair the member entities 108 to the digital monetary repository 127. Additionally, the membership component 202 can store the one or more entity rosters in the memory 118 and/or share the entity roster with the one or more associate components of the repository management component 102 and/or member entities 108. As entities are added to the entity roster, the membership component 202 designates the added entities as member entities 108 that can share parameter preferences 126 and/or repository data 128 with the repository management component 102 with regards to the given digital monetary repository 127 defined and/or updated by the repository component 116. As entities are removed from the entity roster, the membership component 202 remove the given entities' designation as member entities 108. For example, the membership component 202 can elicit and/or analyze one or more votes by the member entities 108 regarding the entity roster.

In one or more embodiments, one or more of the member entities 108 can employ the membership component 202 to generate a proposal and elicit preference parameters 126 regarding the composition of the entity roster. For example, the membership component 202 can generate one or more elicitation protocols to elicit the preference parameters 126. Example elicitation protocols can include, but are not limited to: polls, surveys, questionnaires, elections, a combination thereof, and/or the like. The one or more elicitation protocols can be shared with the member entities 108 as repository data 128. The member entities 108 can thereby generate and/or share responses to the one or more elicitations as preference parameters 126. Further, the membership component 202 can analyze the elicited preference parameters 126 to determine whether a given entity is added or removed from the one or more entity rosters. The membership component 202 can analyze the elicited preference parameters in accordance with one or more defined settings. The defined settings can define one or more thresholds for analyzing the preference parameters. For example, the one or more settings can require a simple majority of the preference parameters to affirm the proposal to execute the proposed adjustment to the entity roster. In another example, the one or more settings can require a unanimous affirmation by the preference parameters to execute the proposed adjustment to the entity roster.

For instance, a member entity 108 can employ the membership component 202 to elicit preference parameters 126 from other member entities 108 regarding whether an undesignated entity should be added to the entity roster and thereby be designated a member entity 108. The membership component 202 can generate one or more elicitation protocols regarding the new member determination, and share the elicitation protocols with the member entities 108. In response, the member entities 108 can answer the elicitation protocols by indicating a preference to add the given entity or to not add the given entity. Further, the member entities 108 can share the responses as preference parameters 126 that can be analyzed by the membership component 202. The membership component 202 can analyze the elicited preference parameters 126 in accordance with one or more defined settings to determine whether the given entity is added to the entity roster.

In another instance, a member entity 108 can employ the membership component 202 to elicit preference parameters 126 from other member entities 108 regarding whether a member entity 108 should be removed from the entity roster and thereby no longer be designated a member entity 108. The membership component 202 can generate one or more elicitation protocols regarding the member removal determination, and share the elicitation protocols with the member entities 108. In response, the member entities 108 can answer the elicitation protocols by indicating a preference to remove the member entity 108 or to not remove the member entity 108. Further, the member entities 108 can share the responses as preference parameters 126 that can be analyzed by the membership component 202. The membership component 202 can analyze the elicited preference parameters 126 in accordance with one or more defined settings to determine whether the given entity is removed from the entity roster.

Additionally, in various embodiments the membership component 202 can generate one or more elicitation protocols to ascertain which member entity 108 from the entity roster is designated, by the membership component 202, as the management delegate of the member entities 108. As described herein, the management delegate can be granted management access by the access component 112. Included with the management access can be the ability to define one or more settings of the repository management component 102. Example settings that can be defined by the management delegate can include, for instance, the one or more threshold settings guiding the analysis of the membership component 202, as described herein. In one or more embodiments, the management delegate can also define the one or more distribution policies that guide the funds distribution performed by the distribution component 114.

For instance, a member entity 108 can employ the membership component 202 to elicit preference parameters 126 from other member entities 108 regarding whether a given member entity 108 should be designated the management delegate. The membership component 202 can generate one or more elicitation protocols regarding the management delegate determination, and share the elicitation protocols with the member entities 108. In response, the member entities 108 can answer the elicitation protocols by indicating a preference to designate the given member entity 108 as the management delegate or to not designate the given member entity 108 as the management delegate. Further, the member entities 108 can share the responses as preference parameters 126 that can be analyzed by the membership component 202. The membership component 202 can analyze the elicited preference parameters 126 in accordance with one or more defined settings to determine whether the given member entity 108 is designated the management delegate.

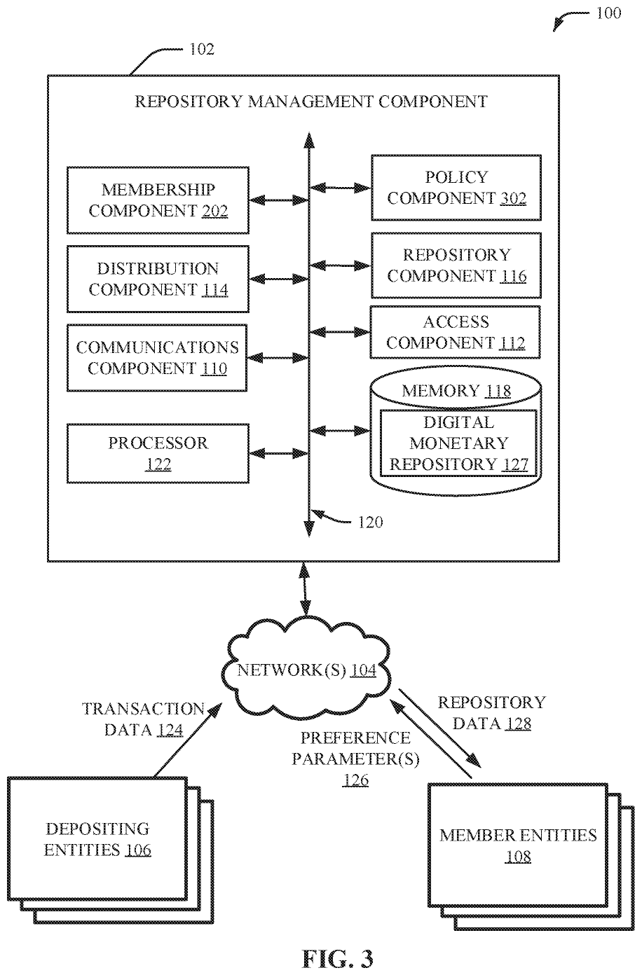

FIG. 3 illustrates a diagram of the example, non-limiting system 100 further comprising policy component 302 in accordance with one or more embodiments described herein. Repetitive description of like elements employed in other embodiments described herein is omitted for sake of brevity. In various embodiments, the policy component 302 can define the one or more distribution policies implemented by the distribution component 114.

In one or more embodiments, one or more of the member entities 108 can employ the policy component 302 to generate a proposal and elicit preference parameters 126 regarding the creation and/or modification of one or more distribution policies. For example, the policy component 302 can generate one or more elicitation protocols to elicit the preference parameters 126. Example elicitation protocols can include, but are not limited to: polls, surveys, questionnaires, elections, a combination thereof, and/or the like. The one or more elicitation protocols can be shared with the member entities 108 as repository data 128. The member entities 108 can thereby generate and/or share responses to the one or more elicitations as preference parameters 126. Further, the policy component 302 can analyze the elicited preference parameters 126 to determine whether a proposed distribution policy setting and/or feature is approved and/or preferred by the member entities 108. The policy component 302 can analyze the elicited preference parameters in accordance with one or more defined settings. The defined settings can define one or more thresholds for analyzing the preference parameters. For example, the one or more settings can require a simple majority of the preference parameters to affirm the propose distribution policy settings to execute the distribution policy. In another example, the one or more settings can require a unanimous affirmation by the preference parameters to execute the proposed distribution policy.

In various embodiments, the policy component 302 can autonomously generate one or more distribution policy proposals and/or elicit preference parameters regarding the autonomously generated proposal from the member entities 108. For example, the policy component 302 can autonomously generate one or more distribution proposals based on distribution policy settings previously approved by the member entities 108. In one or more embodiments, the policy component 302 can employ one or more artificial intelligence technologies, such as machine learning, to autonomously generate the one or more distribution policy proposals. In one or more embodiments the policy component 302 can also generate distribution policy proposals based on governing financial guidelines. For example, the governing financial guidelines may define one or more regulations that become relevant based on the transaction data 124 and/or entity roster. For instance, one or more governing financial guidelines may become relevant once a deposit amount exceeds a defined threshold. In another instance, one or more governing financial guidelines may become relevant once the membership count of the entity roster exceeds a defined threshold. One of ordinary skill in the art will recognize that the relevancy of a wide range of governing financial guidelines can be based on thresholds which can be readily analyzed by artificial intelligence technology employed by the policy component 302. The policy component 302 can identify the relevant governing financial guidelines based on the defined thresholds and generate the proposed distribution policy settings based on the relevant governing financial guidelines. Thereby, the policy component 302 can autonomous propose distribution policy settings to facilitate compliance with the governing financial guidelines by the member entities 108.

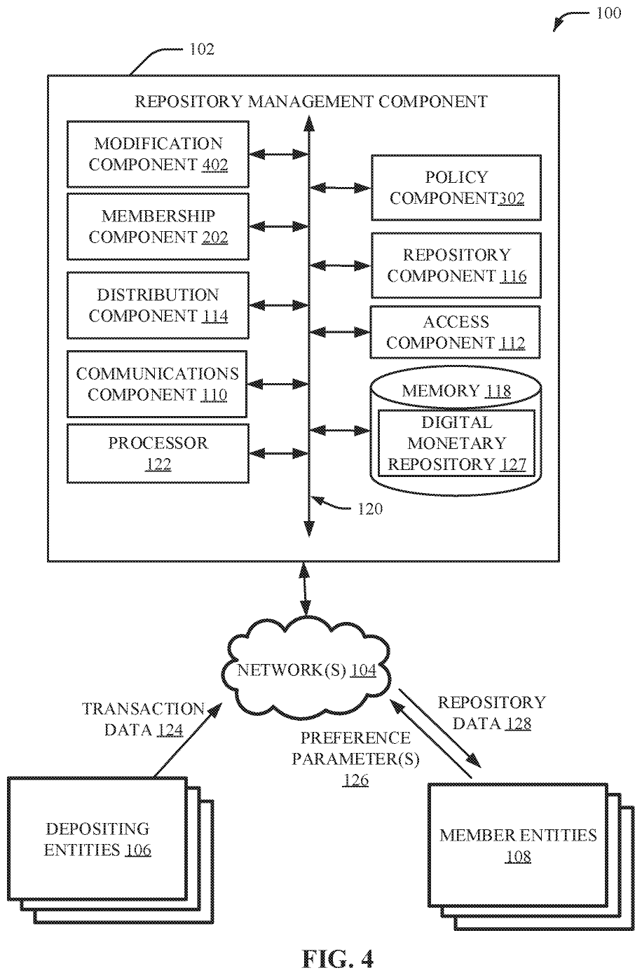

FIG. 4 illustrates the example, non-limiting system 100 further comprising modification component 402 in accordance with one or more embodiments described herein. Repetitive description of like elements employed in other embodiments described herein is omitted for sake of brevity. In various embodiments, the modification component 402 can modify the one or more distribution policies based on one or more conditions set by the one or more management delegates.

In various embodiments, the one or more management delegates of the member entities 108 can employ the modification component 402 to modify one or more distribution policies based on one or more triggering conditions. For example, the triggering conditions can be based on, but not limited to: the source of a deposit, the amount of a deposit, the balance of the digital monetary repository, the composition of the entity roster, one or more schedules, a combination thereof, and/or the like. For instance, the modification component 402 can modify one or more distribution policies by altering the amount of funds to be distributed and/or which member entities 108 receive the distribution.

In one or more embodiments, the distribution policies can be defined and/or agreed upon by the one or more member entities 108 via preference parameters 126 and/or the policy component 302, wherein modifications to the distribution policies can be defined by the one or more management delegates via preference parameters 126 and/or the modification component 402. Thereby, general distribution principals can be collectively established by the member entities 108 and adjusted based on specific contexts by the management delegate. Alternatively, in various embodiments the modifications implemented by the modification component 402 can also be established and/or approved by the member entities 108. For example, the one or more member entities 108 can employ the modification component 402 to propose one or more distribution policy modifications via the modification component 402; rather than propose one or more new distribution policies via the policy component 302 that may contradict previously established distribution policies. The modification component 402 can generate and/or share the one or more elicitation protocols regarding the proposed modifications to elicit preference parameters 126 from the one or more member entities. Further, the modification component 402 can analyze the preference parameters in accordance with one or more settings, as described with regards to the various embodiments herein.

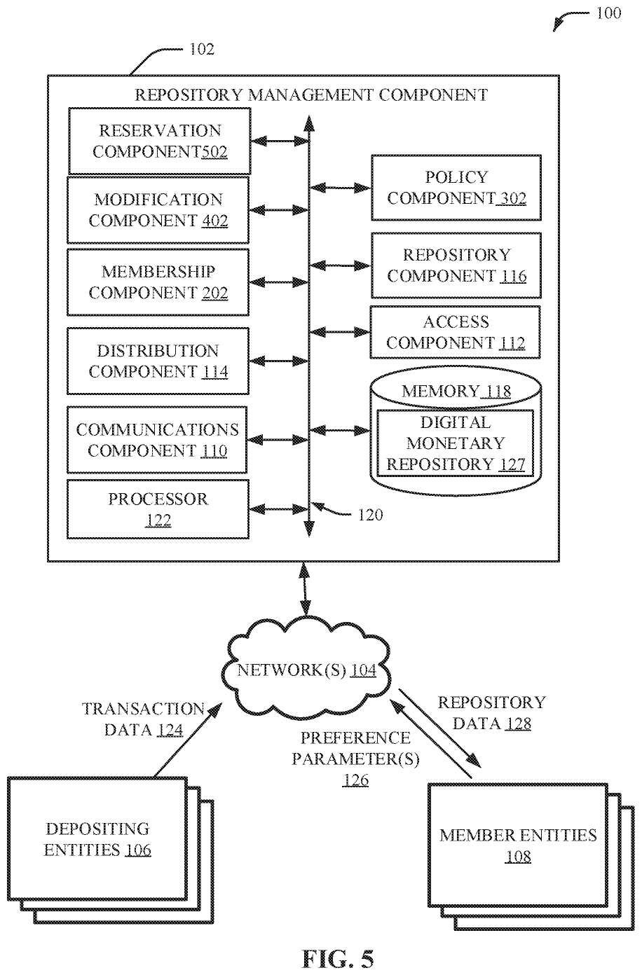

FIG. 5 illustrates a diagram of the example, non-limiting system 100 further comprising reservation component 502 in accordance with one or more embodiments described herein. Repetitive description of like elements employed in other embodiments described herein is omitted for sake of brevity. In various embodiments, reservation component 502 can reserve a portion of the balance of the digital monetary repository 127 from distribution by the distribution component 114. For example, the reservation component 502 can reserve a portion of the balance of the digital monetary repository, and/or a portion of one or more deposits to the digital monetary repository, from distribution amongst by the member entities 108 by the distribution component 114 during implementation of the one or more distribution policies.

In one or more embodiments, reservation component 502 can reserve the balance portion and/or deposit portion within the digital monetary repository 127. Alternatively, in various embodiments the reservation component 502 can reserve the balance portion and/or deposit portion by transferring the balance portion and/or deposit portion to one or more second digital monetary repositories in the financial transaction platform (e.g., wherein the one or more second digital monetary repositories can also be defined and/or updated by the repository component 116). Further, the amount reserved can be set by the one or more management delegates and/or collectively by the one or more member entities 108 via one or more preference parameters 126. For example, the reservation component 502 can generate one or more elicitation protocols regarding one or more reservation policies to elicit preference parameters 126 from the one or more management delegates and/or member entities 108. In accordance with the various embodiments described herein, the one or more elicitation protocols can be sent to the one or more member entities 108 and/or analyzed by the reservation component 502 in accordance with one or more threshold settings.

The one or more reservation policies defined by the preference parameters 126 (e.g., from the one or more management delegates or collectively from the one or more member entities 108) can delineate, for example: an amount of funds to be reserved, how to reserve the funds, and/or how often to reserve the funds. For instance, the amount can be a defined percentage of the digital monetary repository 127 balance or the deposit amount. In another instance, the amount can be a defined sum. Further, the one or more reserve policies can define whether the portion of funds are reserved within the digital monetary repository 127 or within a second digital monetary repository, as described herein. In a further instance, the one or more reservation policies can set the reservations to be implemented by the reservation component 502 in accordance to a defined schedule and/or in response to the occurrence of a deposit.

In various embodiments, the management delegate and/or the member entities 108 can employ the reservation component 502 to define and/or implement one or more reservation policies that can facilitate one or more savings schemes. For example, the management delegate and/or the member entities 108 can employ the reservation component 502 to define and/or implement one or more reservation policies to save funds for a goal and/or prudent financial practice. As described herein, the funds reserved by the reservation component 502 are not subject to distribution when the distribution component 114 implements the one or more distribution policies (e.g., unmodified or modified distribution policies).

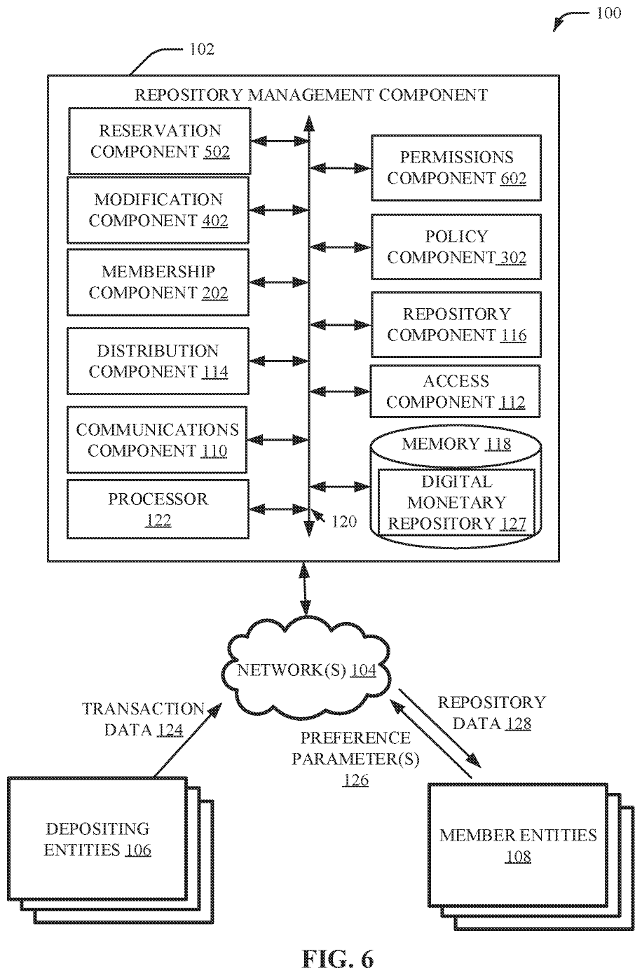

FIG. 6 illustrates a diagram of the example, non-limiting system 100 further comprising permissions component 602 in accordance with one or more embodiments described herein. Repetitive description of like elements employed in other embodiments described herein is omitted for sake of brevity. In various embodiments, the permissions component 602 can authorize a withdraw from the portion of funds reserved by the reservation component 502 based on one or more permissions received from the member entities 108. For example, the reserved funds can remain exempt from withdrawal and/or disbursement until the permissions component 602 authorizes the withdrawal and/or disbursement based on one or more preference parameters 126 received by the member entities 108.

In one or more embodiments, one or more of the member entities 108 can employ the permissions component 602 to generate a proposal and elicit preference parameters 126 regarding the withdrawal and/or disbursement of reserved funds. For example, the permissions component 602 can generate one or more elicitation protocols to elicit the preference parameters 126. Example elicitation protocols can include, but are not limited to: polls, surveys, questionnaires, elections, a combination thereof, and/or the like. The one or more elicitation protocols can be shared with the member entities 108 as repository data 128. The member entities 108 can thereby generate and/or share responses to the one or more elicitations as preference parameters 126. Further, the permissions component 602 can analyze the elicited preference parameters 126 to determine whether a proposed withdrawal or disbursement of the reserved funds is approved. The permissions component 602 can analyze the elicited preference parameters in accordance with one or more defined settings. The defined settings can define one or more thresholds for analyzing the preference parameters 126. For example, the one or more settings can require a simple majority of the preference parameters to affirm the proposal to withdraw and/or disburse reserved funds. In another example, the one or more settings can require a unanimous affirmation by the preference parameters 126 to permit the withdrawal and/or disbursement of the reserved funds.

In various embodiments, one or more member entities 108 can employ the permissions component 602 to facilitate one or more reimbursements of funds incurred by one member entity 108 at the service of the other member entities 108. For example, the reserved funds can be saved for expenditures relating to the member entities 108 collectively, wherein the expenditures can be first incurred by a respective member entity 108 and then reimbursed from the reserved funds upon the permission of the other member entities 108. By predicating withdrawal and/or disbursements of the reserved funds on permissions granted by the permissions component 602, the member entities 108 can be assured that reserved funds are not misappropriated.

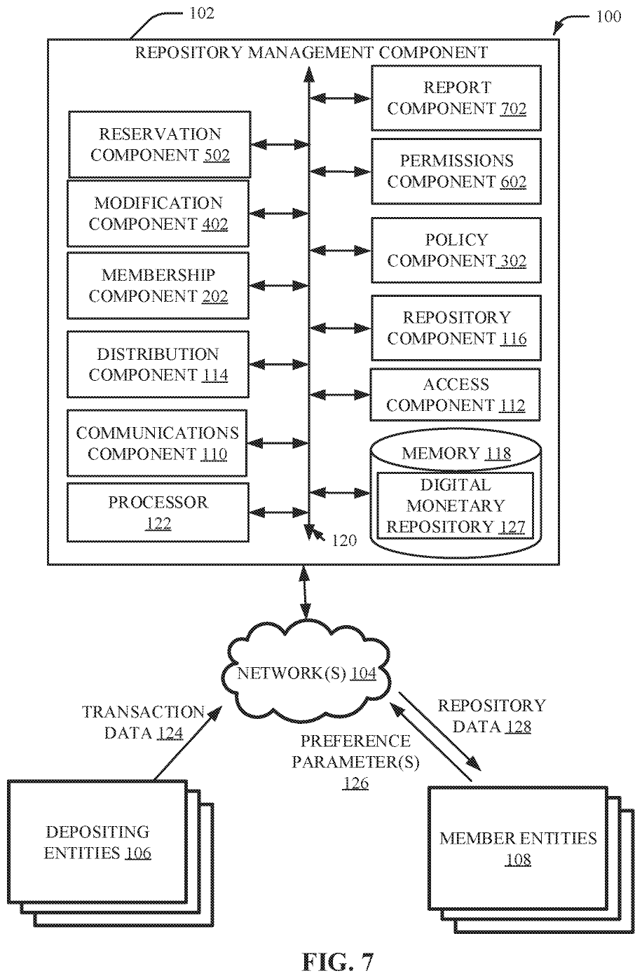

FIG. 7 illustrates a diagram of the example, non-limiting system 100 further comprising report component 702 in accordance with one or more embodiments described herein. Repetitive description of like elements employed in other embodiments described herein is omitted for sake of brevity. In various embodiments, the report component 702 can generate one or more reports regarding the historic status of the digital monetary repository, the transaction data, the distribution policies, one or more settings of the repository management component 102, one or more fund distributions, transactions regarding reserved funds, a combination thereof, and/or the like.

In various embodiments, the reports generated by the report component 702 can comprise text, images, graphs, charts, photographs, a combination thereof, and/or the like. Further, the report component 702 can send the one or more generated reports as repository data 128 to the one or more member entities 108 via the communications component 110 and/or networks 104. In various embodiments, the report component 702 can share the one or more reports with the member entities 108 as a feature of the monitoring access granted by the access component 112.

In one or more embodiments, the report component 702 can generate the one or more reports in response to, and/or with regards to, one or more trigger events. Example triggering events can include, but are not limited to: the occurrence of one or more deposits to the digital monetary fund, the distribution (e.g., via distribution component 114) of one or more funds in accordance with one or more distribution policies, the reservation (e.g., via reservation component 502) of one or more funds in accordance with one or more reservation policies, the modification (e.g., via modification component 402) of one or more distribution policies, the balance of the digital monetary repository 127 surpassing or falling below one or more thresholds, the implementation of one or more settings by the management delegate, the creation of one or more new distribution policies (e.g., via the policy component 302), an alteration to the entity roster (e.g., via the membership component 202), a combination thereof, and/or the like. Additionally, the report component 702 can generate the one or more reports based on one or more preference parameters 126 set by one or more of the member entities 108. For example, a member entity 108 can set a preference parameter 126 that directs the generation of the one or more reports by the report component 702 in response to a preferred triggering event and/or in accordance with a defined schedule (e.g., a defined time interval, such as daily, weekly, etc.).

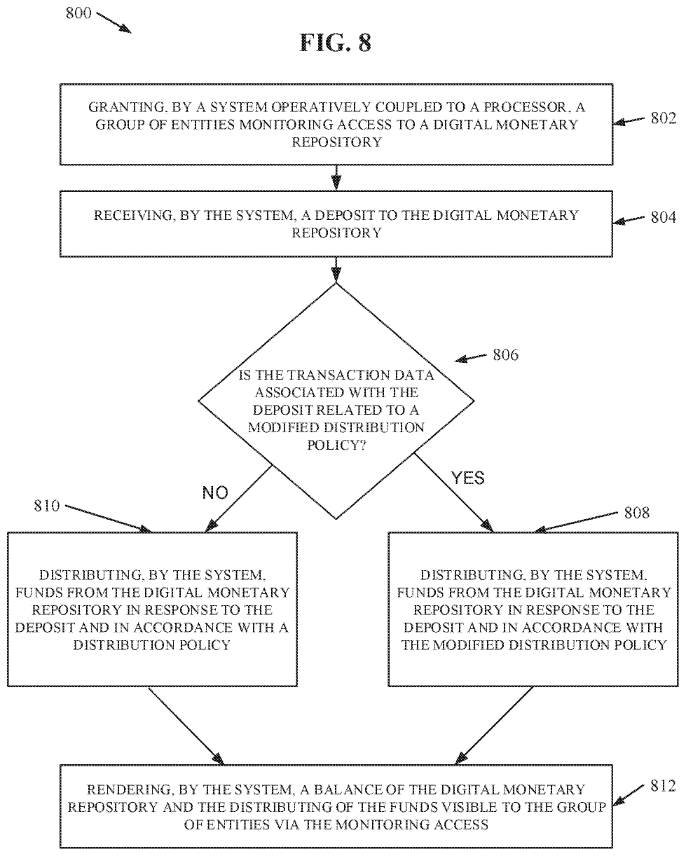

FIG. 8 illustrates a flow diagram of an example, non-limiting computer-implemented method 800 that can regard the management of one or more digital monetary repositories with regards to one or more member entities 108 in accordance with one or more embodiments described herein. Repetitive description of like elements employed in other embodiments described herein is omitted for sake of brevity.

At 802, the computer-implemented method 800 can comprise granting (e.g., via access component 112), by a system 100 operatively coupled to a processor 122, a group of entities (e.g., member entities 108) monitoring access to a digital monetary repository 127. In accordance with various embodiments described herein, the monitoring access can enable the group of entities to view deposits, withdraws, and/or fund distributions associated with the digital monetary repository 127. For example, the monitoring access granted at 802 can enable the group of entities (e.g., member entities 108) to view the transaction data 124 and/or repository data 128 related to the digital monetary repository 127.

At 804, the computer-implemented method 800 can comprise receiving (e.g., via communications component 110), by the system 100, one or more deposits to the digital monetary repository 127. In accordance with various embodiments described herein, the one or more deposits received at 804 can be characterized by transaction data 124. Further, the status of the digital monetary repository 127 (e.g., the balance of the repository) can be updated (e.g., via repository component 116) in response to receiving the transaction data 124 (e.g., via communications component 110 and/or networks 104).

At 806, the computer-implemented method 800 can comprise considering whether the transaction data 124 associated with the deposit received at 804 is related to a modified distribution policy. In accordance with various embodiments described herein, one or more distribution policies regarding the distribution of funds from the digital monetary repository 127 can be modified (e.g., via modification component 402) to address one or more contexts of the deposit. Further, the one or more distribution policy modifications can be employed by a management delegate of the group of entities (e.g., member entities 108) and/or by the group of entities (e.g., member entities 108) collectively.

For example, the one or more modifications to the distribution policy can be related to the transaction data 124 based one or more triggering events. The one or more triggering events can be characterized by the transaction data 124 and/or can regard, for instance: the source of the deposit, the size of the deposit, the time of the deposit, a description of services rendered, a receipt, a transaction identification number, a combination thereof, and/or the like. At 806, the computer-implemented method 800 can analyze (e.g., via the modification component 402) the transaction data 124 to determine whether one or more modification triggering events have occurred. Wherein a modification triggering event has occurred, the transaction data associated with the deposit can be found to be related to a modified distribution policy and the computer-implemented method 800 can proceed to 808. Alternatively, wherein a modification triggering event has not occurred, the transaction data associated with the deposit can be found not to be related to a modified distribution policy and the computer-implemented method 800 can proceed to 810.

At 808, the computer-implemented method 800 can comprise distributing (e.g., via distribution component 114), by the system 100, funds from the digital monetary repository 127 in response to the deposit and in accordance with the modified distribution policy (e.g., generated via modification component 402). In accordance with the various embodiments described herein, the distributing at 808 can be amongst one or more entities from the group of entities granted monitoring access at 802 (e.g., one or more member entities 108). Additionally, the modified distribution policy can delineate one or more modifications to a general distribution policies based on the occurrence of the trigger event. For example, wherein the trigger event is the describes a particular entities from the group of entities within the transaction data 124, the modification to the general distribution policy can be a change from distributing the funds amongst the entire group of entities to distributing the funds amongst the described entities.

Alternatively, at 810 the computer-implemented method 800 can comprise distributing (e.g., via distribution component 114), by the system 100, funds from the digital monetary repository 127 in response to the deposit and in accordance with one or more distribution policies (e.g., generated via policy component 302). In accordance with the various embodiments described herein, the distributing at 808 can be amongst one or more entities from the group of entities granted monitoring access at 802 (e.g., one or more member entities 108). Additionally, the distribution policy can delineate one or more details of the distributing at 810, such as an equal or unequal distribution amongst the group of entities (e.g., member entities 108).

Subsequent to distributing the funds at 808 or 810, the computer-implemented method 800 can proceed to 812 and can comprise rendering (e.g., via report component 702), by the system 100, a balance of the digital monetary repository 127 and the distributing of the funds at 808 or 810 visible to the group of entities (e.g., member entities 108) via the monitoring access. In accordance with various embodiments described herein, the rendering at 812 can be achieved by generating and/or sharing one or more reports with the group of entities (e.g., member entities 108). For example, the one or more reports can regard the deposits, withdraws, and/or fund distributions associated with the digital monetary repository 127.

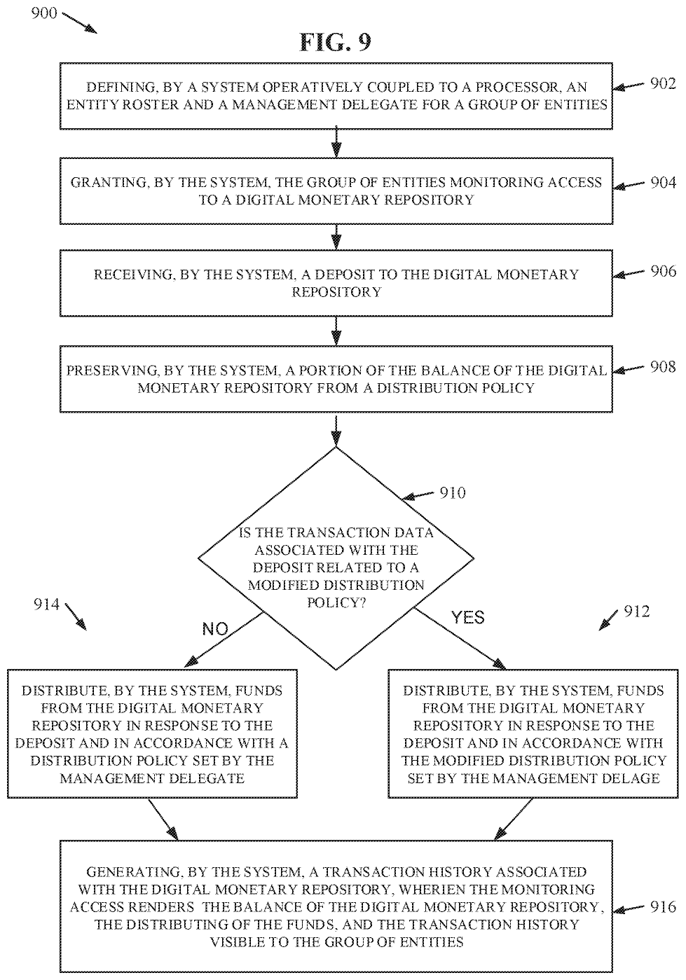

FIG. 9 illustrates a flow diagram of an example, non-limiting computer-implemented method 900 that can regard the management of one or more digital monetary repositories with regards to one or more member entities 108 in accordance with one or more embodiments described herein. Repetitive description of like elements employed in other embodiments described herein is omitted for sake of brevity.

At 902, the computer-implemented method 900 can comprise defining (e.g., via membership component 202), by a system 100 operatively compound to a processor 122, one or more entity rosters and/or a management delegate for a group of entities (e.g., member entities 108). In accordance with various embodiments, the entity roster and/or management delegate can be defined at 902 by eliciting (e.g., via membership component 202) one or more preferences from the group of entities (e.g., member entities 108). For example, one or more elicitation protocols (e.g., polls, surveys, elections, questionnaires, and/or the like) can be sent to the group of entities, wherein responses to the elicitation protocols can form the basis for the defining at 902.

At 904, the computer-implemented method 900 can comprise granting (e.g., via access component 112), the system 100, the group of entities (e.g., member entities 108) monitoring access to a digital monetary repository 127. In accordance with various embodiments described herein, the monitoring access can enable the group of entities to view deposits, withdraws, and/or fund distributions associated with the digital monetary repository 127. For example, the monitoring access granted at 904 can enable the group of entities (e.g., member entities 108) to view the transaction data 124 and/or repository data 128 related to the digital monetary repository 127.

At 906, the computer-implemented method 900 can comprise receiving (e.g., via communications component 110), by the system 100, one or more deposits to the digital monetary repository 127. In accordance with various embodiments described herein, the one or more deposits received at 906 can be characterized by transaction data 124. Further, the status of the digital monetary repository 127 (e.g., the balance of the repository) can be updated (e.g., via repository component 116) in response to receiving the transaction data 124 (e.g., via communications component 110 and/or networks 104).

At 908, the computer-implemented method 900 can comprise preserving (e.g., via reservation component 502), by the system 100, a portion of the balance of the digital monetary repository 127 from a distribution policy. In accordance with various embodiments described herein, the preserving at 908 can be implemented in accordance with one or more reservation policies. For instance, the balance portion can be preserved at 908 in accordance with one or more reservation policies so as to protect an allotted amount of funds from subsequent distribution amongst the group of entities.

At 910, the computer-implemented method 900 can comprise considering whether the transaction data 124 associated with the deposit received at 804 is related to a modified distribution policy. In accordance with various embodiments described herein, one or more distribution policies regarding the distribution of funds from the digital monetary repository 127 can be modified (e.g., via modification component 402) to address one or more contexts of the deposit. Further, the one or more distribution policy modifications can be employed by a management delegate of the group of entities (e.g., member entities 108) and/or by the group of entities (e.g., member entities 108) collectively.

For example, the one or more modifications to the distribution policy can be related to the transaction data 124 based one or more triggering events. The one or more triggering events can be characterized by the transaction data 124 and/or can regard, for instance: the source of the deposit, the size of the deposit, the time of the deposit, a description of services rendered, a receipt, a transaction identification number, a combination thereof, and/or the like. At 910, the computer-implemented method 900 can analyze (e.g., via the modification component 402) the transaction data 124 to determine whether one or more modification triggering events have occurred. Wherein a modification triggering event has occurred, the transaction data associated with the deposit can be found to be related to a modified distribution policy and the computer-implemented method 900 can proceed to 912. Alternatively, wherein a modification triggering event has not occurred, the transaction data associated with the deposit can be found not to be related to a modified distribution policy and the computer-implemented method 900 can proceed to 914.

At 912, the computer-implemented method 900 can comprise distributing (e.g., via distribution component 114), by the system 100, funds from the digital monetary repository 127 in response to the deposit and in accordance with the modified distribution policy (e.g., generated via modification component 402). In accordance with the various embodiments described herein, the distributing at 912 can be amongst one or more entities from the group of entities granted monitoring access at 904 (e.g., one or more member entities 108). Additionally, the modified distribution policy can delineate one or more modifications to a general distribution policies based on the occurrence of the trigger event. For example, wherein the trigger event is the describes a particular entities from the group of entities within the transaction data 124, the modification to the general distribution policy can be a change from distributing the funds amongst the entire group of entities to distributing the funds amongst the described entities.

Alternatively, at 914 the computer-implemented method 00 can comprise distributing (e.g., via distribution component 114), by the system 100, funds from the digital monetary repository 127 in response to the deposit and in accordance with one or more distribution policies (e.g., generated via policy component 302). In accordance with the various embodiments described herein, the distributing at 914 can be amongst one or more entities from the group of entities granted monitoring access at 904 (e.g., one or more member entities 108). Further, the distributing at 914 can regard funds not subject to the preserving at 908. Additionally, the distribution policy can delineate one or more details of the distributing at 914, such as an equal or unequal distribution amongst the group of entities (e.g., member entities 108).

Subsequent to distributing the funds at 912 or 914, the computer-implemented method 900 can proceed to 916 and can comprise generating (e.g., via report component 702), by the system 100, a transaction history associated with the digital monetary repository, wherein the monitoring access can render the balance of the digital monetary repository, the distributing of the funds at 912 or 914, and/or the transaction history visible to the group of entities (e.g., member entities 108).

In accordance with the various embodiments described herein, the system 100 and/or computer-implemented methods 800, 900 can be employed to facilitate the following use-cases regarding management of a digital monetary repository 127 associated with one or more member entities 108. One of ordinary skill in the art will recognize that the following use-cases are described to exemplify the various features described herein.

In a first exemplary use-case, an entity can employ the repository management component 102 to create (e.g., via repository component 116) a digital monetary repository 127. Initially, an entity roster associated with the digital monetary repository 127 can comprise solely the creating entity, designated as a member entity 108. The creating entity can employ the membership component 202 to add one or more additional entities to the entity roster in accordance with the various embodiments described herein. Each added entity can be designated by the membership component 202 as a member entity 108 associated with the digital monetary repository 127. Additionally, each member entity 108 can command a respective digital monetary repository 127 on the financial transaction platform.

The initial member entity 108 can be designated management delegate by the membership component 202 by default, and the status of management delegate can be affirmed or changed by the other member entities 108 via one or more proposals submitted to the membership component 202 in accordance with the various embodiments described herein. Moreover, the management delegate can define one or more distribution policies associated with the digital monetary repository 127 and/or the member entities 108. As described in various embodiments herein, other embodiments in which the distribution policies are establish collectively by the member entities 108 and/or autonomously by the policy component 302 are also envisaged. For example, the distribution policy can define an equal fund distribution amongst all the member entities 108 in response to a deposit to the digital monetary repository, wherein the total amount distributed can be equal to the amount of the deposit.

Subsequently, the member entities 108 can engage in a commercial activity for which they are paid. Example commercial activities can include, but are not limited to: performing music, conducting landscape work, house cleaning, painting, conducting an art performance, a combination thereof, and/or the like. Payment for the commercial activity can be deposited into the digital monetary repository 127 via the financial transaction platform and can be characterized by transaction data 124. Further, the member entities 108 can be notified (e.g., via one or more reports generated by the report component 702) of the deposit in accordance with one or more monitoring access privileges granted to the member entities 108 by the access component 112. Additionally, the repository component 116 can update the balance of the digital monetary repository 127 based on the deposit and thereby trigger the distribution policy. Thereupon, the distribution component 114 can distribute funds from the digital monetary repository 127 amongst the member entities 108 in accordance with the distribution policy. In various embodiments, the notification and/or fund distribution can be sent to the member entities 108 by the repository management component 102 as repository data 128.

In a second exemplary use-case, the context of the first exemplary use-case can be modified such that the distribution policy defines an unequal fund distribution amongst the member entities 108. For example, the distribution policy can define a specific percentage of the deposit amount each member entity 108 will receive via the funds distribution in response to the deposit being received by the digital monetary repository 127. For instance, the distribution policy can define a higher distribution percentage allotted to the management delegate (e.g., in recognition for one or more organizational responsibilities). In another instance, the distribution policy can allot different distribution percentages to respective member entities 108 based on the member entities' 108 sonority in the entity roster. In a further instance, the distribution policy can allot different distribution percentages to respective member entities 108 based on the member entities' 108 contribution to the commercial activity (e.g., based on hours worked). Contributions to the commercial activity can be determined via tracking hardware and/or software associated with the member entities 108. For example, each of the member entities 108 can comprise global positioning systems (“GPS”) that can facilitate determining where a member entity 108 was located during the commercial activity and/or for how long the member entity 108 was at the location. For instance, one or more geo-fence technologies can be employed by the member entities 108 to trigger start and/or stop commands to a timer; thereby, tracking the amount of time the member entity 108 spent within the designated geo-fence location.

In a third exemplary use-case, the context of the first exemplary use-case can be modified such that funds can be distributed in accordance with a modified distribution policy. For example, wherein a member entity 108 was absent from a particular commercial activity, the management delegate can define (e.g., via modification component 402) receiving a deposit associated with the particular commercial activity as a modification trigger in accordance with the various embodiments described herein. For instance, the management delegate can define a modified distribution policy that is triggered in response to the repository management component 102 receiving a deposit associated with the particular commercial activity (e.g., as characterized in the transaction data 124). The modified distribution policy can modify the general distribution policy (e.g., which can direct an equal or unequal fund distribution) such that the absent member entity 108 is not included in the allotment of the distribution funds, and thereby the funds are not disbursed to the absent member entity 108. For instance, the distribution component 114 can distribute the funds in accordance with the modified distribution policy. Thereby, the management delegate can modify the one or more distribution policies based on the context of an associate commercial activity.

In a fourth exemplary use-case, the context of the first exemplary use-case can be modified such that a portion of the deposit is reserved (e.g., via reservation component 502) from distribution prior to implementing a distribution policy or modified distribution policy. For example, the reservation component 502 can reserve a portion of the received deposit in accordance with one or more reservation policies. Further, the one or more reservation policies can be set by the management delegate and/or can define a portion (e.g., a percentage or a fixed value) of each deposit be transferred to a second digital monetary repository 127 that can serve as a savings account for the member entities 108 collectively. The reservation component 502 can implement the one or more reservation policies prior to distribution of the funds by the distribution component 114 in accordance with the one or more distribution policies and/or modified distribution policies. For instance, the reserved funds can be saved for future use by the member entities 108 to buy new equipment, tools, repairs, and/or any other expense related to the member entities 108 as a whole.

In a fifth exemplary use-case, the context of the fourth exemplary use-case can be modified such that the permission is granted (e.g., via permissions component 602) by the member entities 108 to withdraw the reserved funds. For example, one or more member entities 108 can employ the permissions component 602 to propose a group expenditure and/or elicit preference parameters 126 from the other member entities 108 regarding whether the proposed expenditure is approved or denied. Thereby, the reserved funds can be held in savings until such time that the member entities 108 collectively agree to the withdrawal, expenditure, and/or disbursement of the reserved funds.

In each of the use-cases, monitoring access granted to the member entities 108 can enable the member entities 108 to view one or more reports (e.g., generated via report component 702) regarding the operating history of the digital monetary repository 127 and/or the repository management component 102. For example, the one or more member entities 108 can review reports regarding the transaction history associated with the digital monetary repository, including, for example, the transaction data 124. In another example, the one or more member entities 108 can review reports regarding the distribution history associated with the digital monetary repository, including, for example, the repository data 128 sent to the various member entities 108. In a further example, the one or more member entities 108 can review reports regarding the reserved funds, including, for example, a balance and/or transaction history associated with the reserved funds. For instance, the one or more reports generated by the report component 702 and/or accessible to the member entities 108 can describe the funding amount received by each of the member entities 108, the total amount of funds deposited into the digital monetary repository, and/or the total amount of funds reserved for savings. As described herein, the one or more generated reports can comprise graphs, figures, images, timelines, and/or the like to facilitate review by the member entities 108. Additionally, the member entities 108 can employ one or more filters to analyze the one or more reports. In various embodiments, the one or more reports can be shared with the member entities 108 as repository data 128.

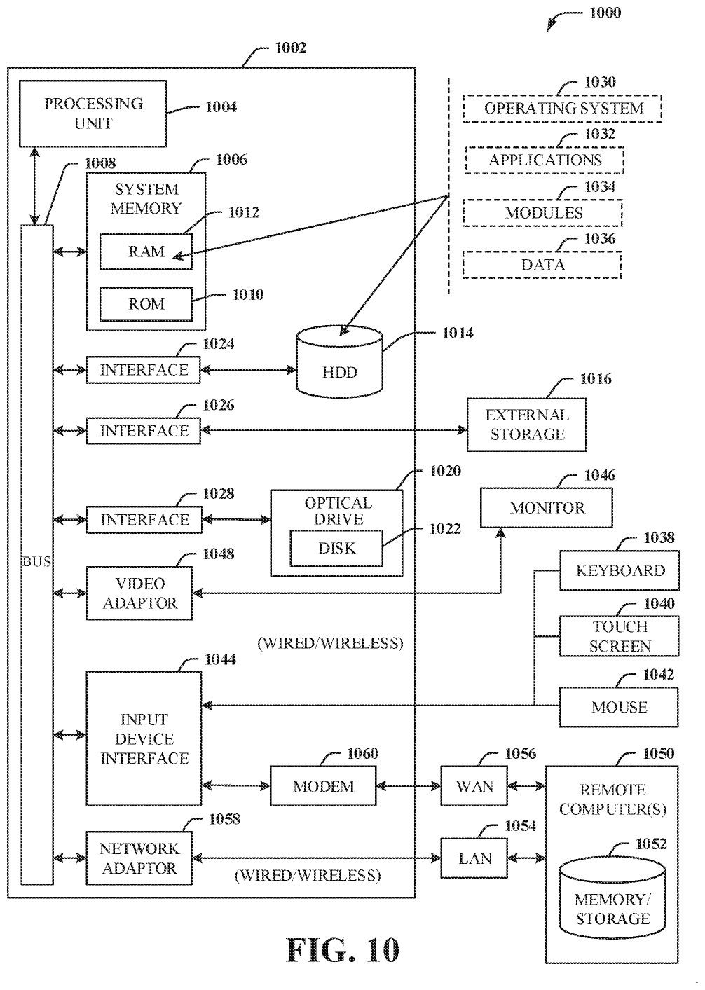

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (“BIOS”) can be stored in a non-volatile memory such as ROM, erasable programmable read only memory (“EPROM”), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (“HDD”) 1014 (e.g., EIDE, SATA), one or more external storage devices 1016 (e.g., a magnetic floppy disk drive (“FDD”) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (“SSD”) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (“VM”) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (“TPM”). For instance with a TPM, boot components hash next in time boot components, and wait for a match of results to secured values, before loading a next boot component. This process can take place at any layer in the code execution stack of computer 1002, e.g., applied at the application execution level or at the operating system (“OS”) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (“LAN”) 1054 and/or larger networks, e.g., a wide area network (“WAN”) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (“AP”) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (“Wi-Fi”) and BLUETOOTH® wireless technologies. Thus, the communication can be a predefined structure as with a conventional network or simply an ad hoc communication between at least two devices.

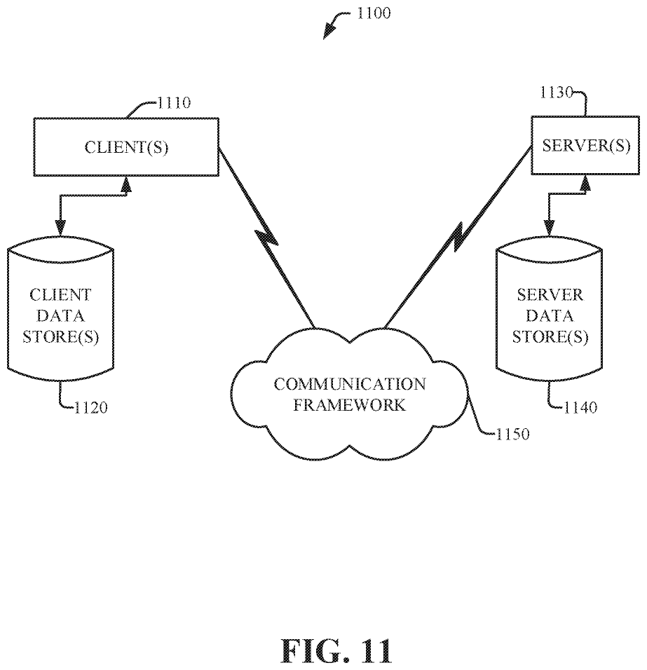

FIG. 11 is a schematic block diagram of a sample computing environment 1100 with which the disclosed subject matter can interact. The sample computing environment 1100 includes one or more client(s) 1110. The client(s) 1110 can be hardware and/or software (e.g., threads, processes, computing devices). The sample computing environment 1100 also includes one or more server(s) 1130. The server(s) 1130 can also be hardware and/or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The sample computing environment 1100 includes a communication framework 1150 that can be employed to facilitate communications between the client(s) 1110 and the server(s) 1130. The client(s) 1110 are operably connected to one or more client data store(s) 1120 that can be employed to store information local to the client(s) 1110. Similarly, the server(s) 1130 are operably connected to one or more server data store(s) 1140 that can be employed to store information local to the servers 1130.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory; and
a processor configured to execute computer instructions stored in the memory that when executed cause the system to perform operations, the computer instructions further comprising:
an access component that provides visibility access to a group of entities regarding transactions associated with a collective of digital monetary deposits, and provides management access to a management delegate of the group of entities; and
a distribution component that in response to action of the management delegate distributes funds from the collective to the group of entities.

2. The system of claim 1, further comprising:
a membership component that manages an entity roster for the group of entities based on a preference parameter received from the group of entities, wherein the entity roster defines a composition of the group of entities.

3. The system of claim 1, further comprising:
a policy component that defines a distribution policy associated with the transactions, wherein the distribution component distributes the funds in accordance with the distribution policy.

4. The system of claim 3, wherein the policy component defines the distribution policy based on a governing financial guideline.

5. The system of claim 3, wherein the distribution policy directs an equal distribution of the funds amongst the group of entities or an unequal distribution of the funds amongst the group of entities.

6. The system of claim 3, further comprising:
a modification component that modifies the distribution policy based on a condition set by the management delegate regarding the transactions.

7. The system of claim 6, further comprising:
a reservation component that reserves a portion of the collective from distribution by the distribution component in response to the repository component receiving the deposits.

8. The system of claim 7, further comprising:
a permissions component that authorizes a withdraw from the portion of the collective reserved by the reservation component based on a permission signal received from the group of entities.

9. The system of claim 8, further comprising:
a report component that generates a report regarding historic status of the collective, wherein the access component further provides visibility access of the report to the group of entities.

10. A computer-implemented method, comprising:
granting, by a system operatively coupled to a processor, a group of entities monitoring access to a digital monetary repository; and
distributing, by the system, funds from the digital monetary repository to an entity from the group of entities in response to a triggering event, wherein the monitoring access renders a balance of the digital monetary repository and the distributing visible to the group of entities.

11. The computer-implemented method of claim 10, further comprising:
defining, by the system, a management delegate from the group of entities, wherein the distributing the funds is performed in accordance with a distribution policy set by the management delegate.

12. The computer-implemented method of claim 11, wherein the triggering event is receiving, by the system, a deposit to the digital monetary repository, and wherein the distribution policy is selected from the group consisting of an equal distribution of the funds amongst entities from the group of entities and an unequal distribution of the funds amongst entities from the group of entities.

13. The computer-implemented method of claim 12, further comprising:
preserving, by the system, a portion of the balance of the digital monetary repository from the distributing based on a fiscal policy set by the management delegate.

14. The computer-implemented method of claim 13, further comprising:
generating, by the system, a transaction history associated with the digital monetary repository, wherein the monitoring access further renders the transaction history visible to the group of entities.

15. A non-transitory computer readable medium comprising instructions that, in response to execution, cause a system including a processor and memory to perform operations comprising:
associating a plurality of entities with a digital monetary repository, wherein the plurality of entities have monitoring access to the digital monetary repository that renders deposits, withdraws, and balances of the digital monetary repository visible; and
distributing funds from the digital monetary repository to one or more entities from the plurality of entities in response to a deposit made into the digital monetary repository.

16. The non-transitory computer readable medium of claim 15, wherein the operations further comprise:
defining a distribution policy that directs how the funds are distributed to the one or more entities.

17. The non-transitory computer readable medium of claim 16, wherein the distribution policy sets a portion of the deposit to be the funds distributed to the one or more entities.

18. The non-transitory computer readable medium of claim 16, wherein the operations further comprise:
transferring a portion of the deposit to a savings account associated with the digital monetary repository prior to a distribution of the funds to the one or more entities, wherein withdraws from the savings account require approval from the plurality of entities.

19. The non-transitory computer readable medium of claim 18, wherein the operations further comprise:
administering a voting ballot to the plurality of entities regarding a requested permission; and
collecting results of the voting ballot from the plurality of entities to determine with the requested permission is approved.

20. The non-transitory computer readable medium of claim 19, wherein the requested permission is a request to withdraw an amount from the savings account.
